(19) United States
(12) Patent Application Publication
(10) Pub. No.: US 2026/0187593 A1
(43) Pub. Date: Jul. 2, 2026

(54) METHOD AND SYSTEM FOR GUIDANCE OF ARTIFICIAL INTELLIGENCE AND HUMAN AGENT TEAMING

(71) Applicant: David Mroczka, Babylon, NY (US)

(72) Inventor: David Mroczka, Babylon, NY (US)

(21) Appl. No.: 19/419,331

(22) Filed: Dec. 15, 2025

Related U.S. Application Data
(63) Continuation-in-part of application No. 18/229,832, filed on Aug. 3, 2023, now abandoned.
Application No. 18/229,832 is a continuation of application No. 16/946,949, filed on Jul. 13, 2020, now abandoned.
(63) Continuation of application No. 18/585,799, filed on Feb. 23, 2024, now abandoned.
(60) Provisional application No. 62/873,180, filed on Jul. 11, 2019.

(51) Int. Cl. G06Q 10/101; G06Q 10/0635; G06Q 10/0637; G06Q 30/0202

(52) U.S. Cl. CPC G06Q 10/101; G06Q 10/0635; G06Q 10/06375; G06Q 30/0202

(57) ABSTRACT

A method for generating an optimal set of parameters for a design project of a product, in which subject matter experts, working with an artificial intelligence module, select a number of fundamental measurement factors that are related to a group of fundamental prime measurements, all of which in the aggregate comprise a product profile matrix. The fundamental measurement factors are weighted and scored so that the resulting matrix reflects the various aspect of the proposed design. Through an iterative process, the fundamental measurement factors are modified until the product profile matrix provides a set of satisfactory scores that yields an acceptably low risk in proceeding with the selected design.

### TECHNICAL FIELD

This invention relates to the use of artificial intelligence in conjunction with human agents in order to develop sets of optimized parameters implemented in product development, design and manufacturing.

### BACKGROUND OF THE INVENTION

Many organizations, whether in the private or government sectors, are continuously seeking to develop new products (goods or services) and/or improve on existing products. In any product design or re-design, there are numerous parameters that need to be considered by the product designer, that may relate to the specifics of the product itself, the personnel utilized to design the product, the marketplace, financial considerations, and the like. Certain of these design parameters are unique to some products, while some may overlap with other products. In some cases, a set of design parameters may be more important than in other cases. Product designers may be able to utilize information from prior designs, while in some cases there are parameters that are new and evolving and thus cannot be repeated from prior designs.

Often, these design parameters are disorganized, and the design process occurs in essentially an ad hoc manner. This often leads to inefficiencies in the product, inconsistencies across products from the same entity, and other like problems.

For example, the government may be seeking to advance the state of the art of products that it uses. As related to defense department activities, this may apply to any aspect of its organization from weapons systems and soldier equipment to medical products and information systems. In order to develop the most effective procurement actions, the government must select the best products for renewal or replacement. It must clearly state to its industrial supply base what it wants to accomplish, and it must determine the path that best benefits the military while effectively managing its budgets.

The government must interrogate proposals to determine which supplier presents the best value and lowest acceptable risk for the desired product. As such, it is essential to utilize the same criteria for selection as was used to develop the procurement product requirements.

The government also needs to track progress after the award of contracts. Risks should be known and not discovered after the fact. Risks should continuously be reduced, and product developments should be progressing towards higher technology readiness levels while meeting the original stakeholder requirements.

The development of a standardized powerset framework and process approach allows human and machine learning to be better organized and methods for capturing decisions and results in context can be formulated. When a comprehensive holistic framework and resulting processes executed from the framework are sufficiently designed, they can account for vastly different risks and mitigation or innovation opportunities. Such a framework can enable guidance for a multitude of technologies, for a multitude of applications and provide a standard method for interfacing with machine learning and AI to sharpen and accelerate delivery of intelligence for enhanced human decision-making.

### SUMMARY OF THE INVENTION

One of the primary goals of this invention is to enable users to remove risks and inconsistencies in product development cycles (i.e. barriers and vulnerabilities) via inputs provided by subject matter experts and a set of scoring methodologies that implement a set of defined fundamental prime measurements. In essence, by defining and scoring these fundamental prime measurements (as will be further explained herein), there will be no risks to the product development cycle that exist outside of the three power sets of fundamental prime measurements (defined as the product fundamental prime measurement power set, the stakeholder fundamental prime measurement power set, and the market fundamental prime measurement power set.). Note that when used herein, a product includes goods and/or services, and a stakeholder may be any individual or organization.

By way of the system of present invention, different subject matter experts from various fields are able to universally access the system, via a user interface platform, with a common approach for providing scoring (i.e., weighting and ratings) to the various fundamental prime measurements as defined by the system. These weighted and scored fundamental prime measurements are then used to provide a more robust, efficient, consistent, cost-effective product design than what was otherwise available in the prior art. Artificial intelligence may also be used by the subject matter experts to make recommendations for the selection of subject matter experts to achieve the best team expertise, development and diversity, provide solution recommendations, as well as recommendations to minimize risk for a given project.

Thus, as further described herein, provided is a computer-implemented method for generating a set of parameters for a design of a product comprising generating, by a computer, a product profile matrix that comprises a power set of fundamental prime measurements, wherein each of said fundamental prime measurements comprises a power set of fundamental measurement factors associated with a design aspect of the product. The product profile matrix is generated by: (i) for each of the fundamental prime measurements, selecting from a project database a plurality n of fundamental measurement factors relevant to the fundamental prime measurement, (ii) assigning a weight of importance W to each of the plurality of fundamental measurement factors, (iii) assigning an evidence score MF to each of the plurality of fundamental measurement factors, (iv) generating a strategic score FPM for each fundamental prime measurement as a function of the weight W and evidence score MF for each of the n fundamental measurement factors by implementing the algorithm

$$FPM = \frac{( {MF}_{1} \times {W}_{1} ) + ( {MF}_{2} \times {W}_{2} ) + … ( {MF}_{n} \times {W}_{n} )}{{W}_{1} + {W}_{2} + … {W}_{n}}$$

$$= \frac{{\sum }_{1}^{n} ( {MF}_{n} \times {W}_{n} )}{{\sum }_{1}^{n} {W}_{n}}$$

(v) generating a set of composite scores for the power set of fundamental prime measurements as a function of the strategic scores, (vi) comparing each composite score to a risk scale to determine if the composite score of the fundamental prime measurement is acceptable, and (vii) if a composite score is below an acceptable risk level of the risk scale, then modifying at least one of the constituent fundamental measurement factors and repeating steps (ii)-(vi) until the composite score is not below the acceptable risk level of the risk scale, resulting in an optimized set of parameters for the design of the product. In some cases, the at least one constituent fundamental measurement factor is modified by providing a modified evidence score MF. Or, the at least one constituent fundamental measurement factor is modified by providing a modified weight W. Optionally, the risks are classified as a gap, vulnerability or barrier, and the process terminates if any composite score or strategic score equates to a barrier.

In one embodiment as shown in FIG. 1, a product profile matrix is defined to include a product fundamental prime measurement power set that includes product appeal, product value, and product reliability; a stakeholder fundamental prime measurement power set is defined to include personnel, stakeholder process, and stakeholder finances; and a market fundamental prime measurement power set is defined to include market size, market demand, and market delivery. As utilized herein, a power set of a set S is the set of all of S's subsets, and it includes any and all possible constituents, as shown in FIG. 4B. See also https://www.ics.uci.edu/˜alspaugh/cls/shr/powerset.html.

Optionally, the total point scores are stored in a database for reuse in a subsequent design project. Further optionally, at least one of the fundamental measurement factors selected from the project database may have an associated previous total point score.

In some instances, artificial intelligence may be used to assist the subject matter experts in selecting the fundamental measurement factors that are used to form the fundamental prime measurement power sets in the product profile matrix. Or, in the alternative, artificial intelligence may be used to replace the subject matter experts in selecting the fundamental measurement factors. Notably, artificial intelligence may be used for recommendations for subject matter expert selection, recommendations for technology proliferation to new applications, recommendations of subject matter experts and technologies that can be integrated, recommendations of previously successful prime measurement factors from similar technologies, recommendations for evidence scoring (explained below), and a repository of all data for future use.

### BRIEF DESCRIPTION OF THE DRAWING

FIG. 1 is a block diagram of the overall system and user interactions of the preferred embodiment of the present invention.

FIG. 2A illustrates generation of the product fundamental prime measurements from groupings of the relevant fundamental measurement factors which are included in the product profile matrix used by the preferred embodiment of FIG. 1.

FIG. 2B illustrates generation of the stakeholders fundamental prime measurements from groupings of the relevant fundamental measurement factors which are included in the product profile matrix used by the preferred embodiment of FIG. 1.

FIG. 2C illustrates generation of the market fundamental prime measurements from groupings of the relevant fundamental measurement factors which are included in the product profile matrix used by the preferred embodiment of FIG. 1.

FIG. 3 is a flowchart of the overall methodology implemented by the preferred embodiment of FIG. 1.

FIG. 4A is a graphical representation of a basic power set.

FIG. 4B is a graphical representation of the power set defined by the product profile matrix in the preferred embodiment of FIG. 1.

FIG. 5 is a three-stage growth matrix showing iterative revisions made to the nine fundamental prime measurements of the product profile matrix of the preferred embodiment of FIG. 1.

FIG. 6 is a screen shot of a web page interface implemented by the preferred embodiment of FIG. 1.

FIG. 7 is a flowchart illustrating the risk/MF search with the current project or keywords.

### DETAILED DESCRIPTION OF THE INVENTION

### Overall View

The framework described herein has been constructed as a mathematical powerset to account for broad-ranging technology and application needs. The usage of a powerset guidance framework does not preclude but enhances the organization of many other techniques and methodologies that assist in selection and development of technologies.

The preferred embodiment of the present invention utilizes databases that result in the creation of actionable intelligence, actionable planning, and execution for more success with higher-risk efforts. Additional objectives of the powerset guidance framework are to:
Quantify objective decision options
Create a comprehensive technology readiness roadmap
Provide a simple health assessment picture
Link risks to success factors and evidence
Establish a maturity model for the technology and organization providing the development activity

### Powerset Construct Introduction

A holistic risk assessment and mitigation framework has been established using a novel mathematical powerset guidance system. In mathematics, the powerset is the set of all possible subsets, therefore it is inclusive of all possible options that can exist. The powerset implemented in the present invention is novel due to its multi-tier nature and its application to complex technology, business, and market application problems.

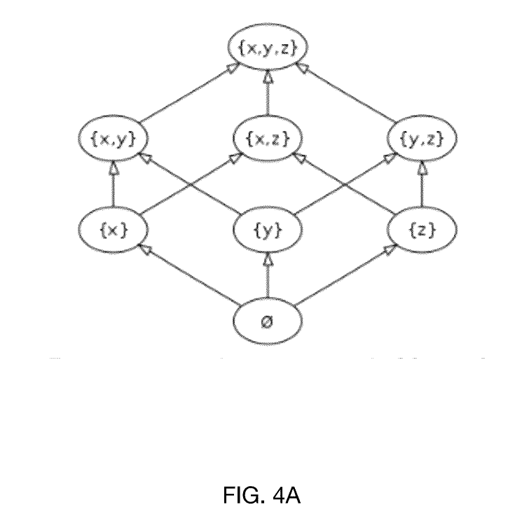

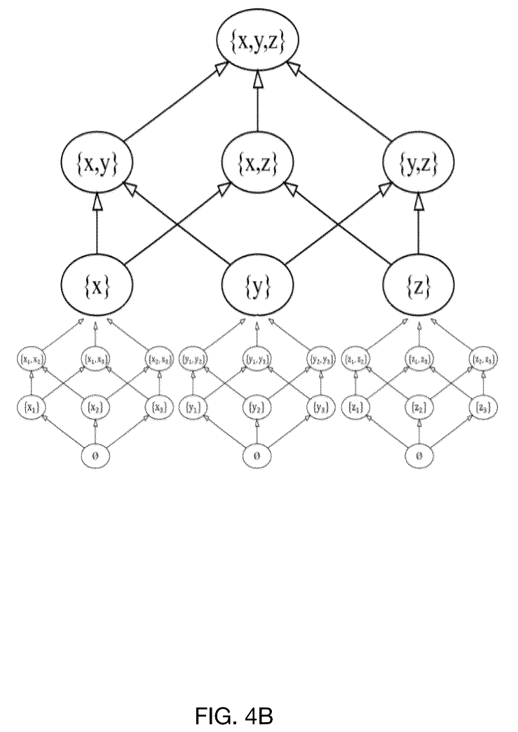

A conventional powerset is represented as shown in FIG. 4A. The powerset implemented in the present invention is configured in multiple tiers as shown in FIG. 4B.

The elements of the top tier are represented by:

| | | |
|---|---|---|
| Product | Team & | Market |
| Technology(X) | Stakeholders(Y) | Application(Z) |

The lower tier elements include:

| | | |
|---|---|---|
| X1 = Appeal | Y1 = Personnel | Z1 = Size/Scope |
| X2 = Value | Y2 = Planning & | Z2 = Demand |
| | Processes | |
| X3 = Reliability | Y3 = Finances | Z3 = Access/ |
| | | Delivery |

Thus, each top tier element is further defined by another powerset represented by its subset elements as follows:

| Product | Team & | Market |
|---|---|---|
| Technology(X) | Stakeholders(Y) | Application(Z) |
| X1 = Appeal | Y1 = Personnel | Z1 = Size/Scope |
| X2 = Value | Y2 = Planning & | Z2 = Demand |
| | Processes | |
| X3 = Reliability | Y3 = Finances | Z3 = Access/ |
| | | Delivery |

The nine lower tier elements are referred to as nine Fundamental Prime Measurements (FPMs). The nine FPM categories therefore are inclusive of all possible risks and the success factors that are designed to mitigate those risks. This encompasses the elements required to successfully bring a product technology to a market application.

The designation of the three top tier and nine lower tier elements are designated as the structural matrix elements and do not get reconfigured from project to project. They have established a functional pathway for interactions that provide both human guidance and machine learning. They have been established with the following rationale and research.

Top Tier Elements: These three elements represent the activity of a Product Technology being developed with a Team and Stakeholders for specific Market Applications, i.e.; “Taking a product to market”.

Lower Tier Elements: Since the Top tier alone does not provide sufficient granularity or clarity to identify and map out finer points of investigation or the analysis and execution of a development plan, we further defined each top tier element with its own supporting powerset. The objective was to identify the fewest number of elements that could encompass a true powerset of capabilities for each top tier element that would still yield a powerset for guidance of any technology or application. The resulting outcome was a minimum of three sub-elements for each top tier element. This structure results in nine fundamental prime measurements (FPMs) that are used for every assessment of developing a technology for an application(s). The identification and validation of these nine elements occurred by collecting and aggregating risks and success factors associated with product and technology development projects. Successful and failed projects and associated failure modes for aerospace, defense, materials, electronics, automotive, medical, pharmaceutical, consumer, and industrial projects were analyzed to validate that every failure mode encountered, as well as their precursor risk or resulting success factor could be captured within the nine FPMs of this system.

### The Integrated Solution

This powerset structure is the basis for the design of the preferred embodiment that is used to manage problems where product technologies are being developed or manufactured by the Team and Stakeholders for delivery to the Market Application. This construct has been and will continue to be used to evaluate and guide any technology for any application. This may be accomplished at the project level for a single discrete technology or product offering, or it may be used for modelling within an entire government or business organization.

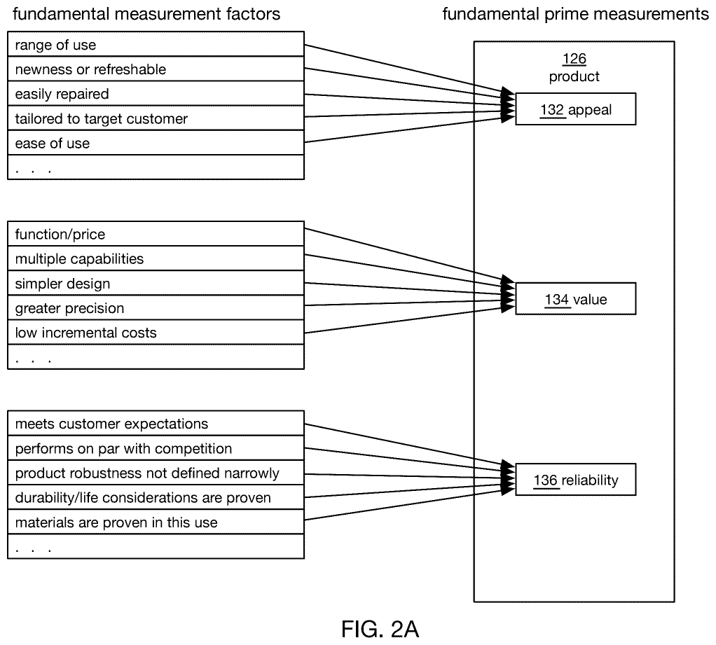

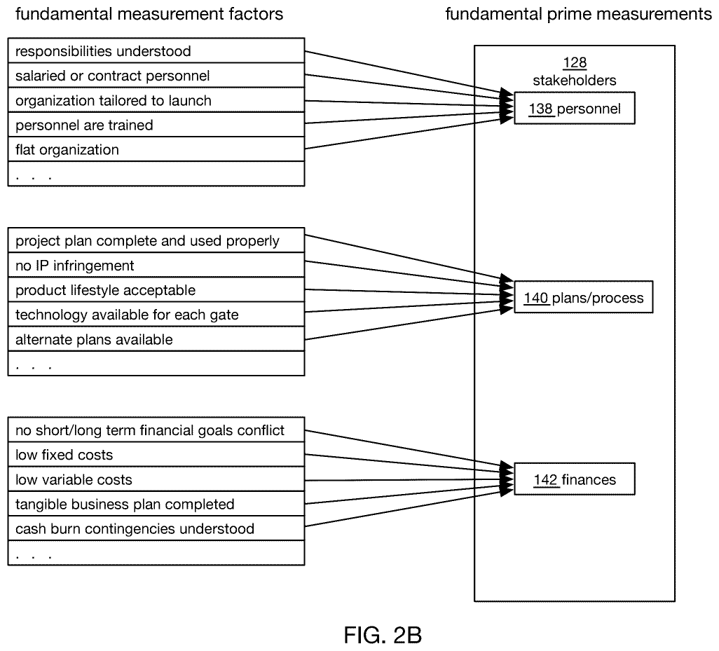

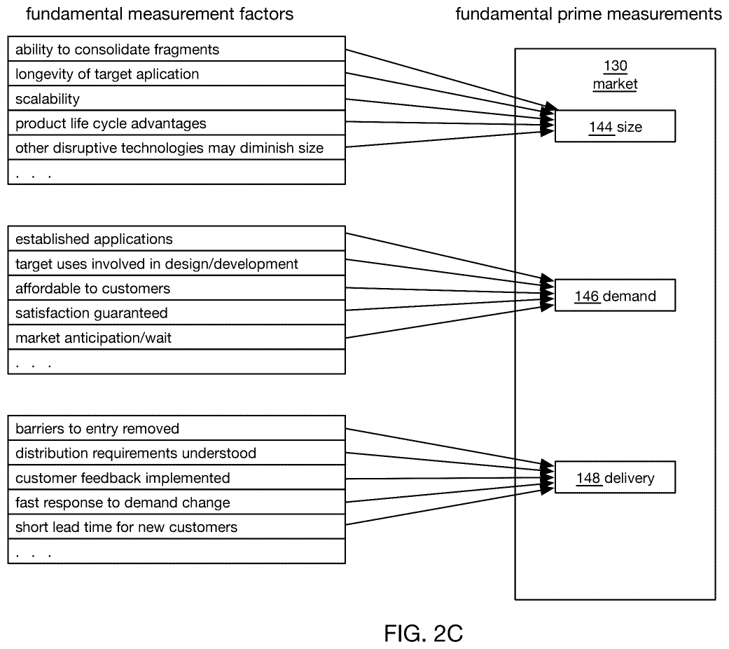

Referring to FIG. 2A, under Product Technology, defined are the appeal FPM 132 (what is wanted from the product technology), the value FPM 134 (features or capabilities that are provided by the product technology) and reliability FPM 136 (all experiences after the technology is delivered and use begins).

Referring to FIG. 2B, under the Team & Stakeholders, defined are the personnel FPM 138 (skills and experience needed to successfully identify and overcome risks and generate evidence), the planning and processes FPM 140 (all coordinated plans and activities of the organization to meet objectives) and finances FPM 142 (funds for implementing changes and KPIs related to costs, profitability, and sales revenue associated with the project).

Referring to FIG. 2C, under the Market Application, defined are the size and scope FPM 144 (of the market application for all applications targeted), the demand FPM 146 (demand created within that market for the product technology), and the access and delivery FPM 148 (relates to the team, data, and products to/from the marketplace and customers).

By establishing a holistic powerset guidance system, we establish a framework that helps users to understand every priority aspect that needs to be considered by a business or government organization to pursue resolution of a risk at hand. Project templates have been modeled and built into the software platform to support government and/or industry selection of products and technologies for investment. These modules are compatible with the acquisition cycle that the US government and large enterprises typically use to select a product or technology for investment. Likewise, a project module also exists for development or implementation of new products and technologies, or any innovation or risk reduction effort desired by the host organization.

Using this two-tier powerset system, we provide alignment between the features and capabilities of products and technologies under consideration and the application needs of the customers or organizations that they're serving. The powerset also models the organization that will perform any development activities, and risk mitigation or implementation/integration of that technology for that new application.

### Decision Guidance for Improved Outcomes

This system and methodology strictly provide decision guidance; it does not make automatic final decisions. Rather, it is designed to provide a structured repeatable process to a team of subject matter experts that will be selecting and developing a product technology. It does so by providing recommendations based on the product technology, team and stakeholder and market application in question. The first step in the process is to assess if the team being assembled has the necessary skills and experience needed to manage the effort. If not, additional personnel can be selected based on profiles of employees and experts that are available.

In the preferred embodiment, five specially designed AI agents draw data from an embedded human-vetted database, or optionally from the public internet by utilizing a curated GPT pipeline. For government and large enterprise applications, the GPT pipeline can have another alternate source of ML data fed from their legacy databases and selectively can be supplemented with or without the public internet. Thus, there are four total sources of data being fed through various pipelines to the project at hand. So, depending on the user organizations appetite and tolerance for various data sources, it may select how its pipelines to source data will be configured in its customized enterprise deployment.

The two tier powerset guidance system represents the universe of potential actions and mitigation activities needed to reduce the risks that can potentially cause failures. The two-tier power set guidance system addresses risks to the business or government organization, or any specific project conducted by them.

When we define and discuss risks, we use three strict definitions to categorize every type of risk. Every risk that can exist in this powerset can be considered as either a gap, a barrier, or a vulnerability. It's very important to tag each risk with one of these labels. Gaps and vulnerabilities can be overcome with mitigation activities, however, barriers cannot. Barriers are things that limit progress to the point of preventing success especially at higher Technology Readiness Levels (TRLs). Barriers are such things as laws, restrictions in physics, restrictions in materials, or require things that have not been invented yet. When a barrier is identified, it is much better to find an alternate solution, resolution, or mitigation instead of attempting to find a success factor for that barrier risk. Barriers in low TRLs of 1-3 are more commonplace and it is almost expected that barriers may initially exist that are tied to specific objectives of principal development activities of low TRL projects.

After identifying the risks associated with each of the three top tier lanes for any given problem or scenario, the SME Team & AI Agents collaboratively identify the success factors within each of the nine FPMs that will mitigate those risks. Success factors are the activities that will be required for implementation and risk mitigation. Each success factor is rigorously debated by the SMEs through team collaboration within the system and tailored to the problem at hand.

The tailored success factors are then linked and mapped specifically to the risks previously identified to ensure that all risks are addressed and to ensure that the proper and most efficient mitigation activities are being utilized in order to mitigate those risks.

When all success factor definitions and risk mappings are finalized, the success factors are weighted and given initial scores based on the starting body of evidence available for each success factor. The final step of deriving the development and/or risk mitigation plan is for the SME team, electively working together with AI agents, to recommend the evidence needed to quantitatively drive up the scores assigned to each success factor. During execution of the development or mitigation activities, evidence is captured and made available for review via the software platform and the relevant scores of any applicable success factors are increased accordingly. As development proceeds and more evidence is produced, scores continue to advance per system guidance.

When scores reach a level of 9, the risks have been successfully mitigated. This system provides immediate visibility into both the health of the project, as well as the maturity model for the product technology and the organization that is performing the work.

### Preferred Embodiment

In particular, the preferred embodiment of the present invention herein implements a system that is referred to as a Product Innovation Platform (PIP). Companies in various industries are able to bid on solicitations generated by the Product Innovation Platform. In the preferred embodiment, an innovation expert network (IEN) is comprised of multiple subject matter experts (SMEs) that operate in conjunction with the Product Innovation Platform as further described herein.

Subject matter experts assist the customer of the Product Innovation Platform (e.g. the government or a private entity) in determining a set of fundamental measurement factors (FMFs) that are geared towards specific products of interest. This is done manually by the SMEs as well as by using artificial intelligence. Eventually, the fundamental measurement factors are applied to a set of nine fundamental prime measurements (FPMs) that together comprise a product profile matrix (PPM) as described above. The SMEs assist along with AI in determining measurements, conducting analysis, and providing specific knowledge related to products and technologies using these fundamental measurement factors to generate the product profile matrix. The product profile matrix in the preferred embodiment is a three-by-three matrix comprised of the nine top level and thus most essential aspects of developing a technology/product by a company and delivering it to the market.

Companies can remove and/or reduce risks, accelerate development activities, and create value by targeting the most critical development activities. This may be done via continual improvement of the product profile matrix scores. The company can also communicate internally, to team members, and to the government by communicating their scores and related development activities.

This patent application is based on the previously co-pending U.S. provisional application Ser. No. 62/873,180 of the inventor, entitled NOVEL SYSTEM FOR GUIDANCE OF ARTIFICIAL INTELLIGENCE AND HUMAN AGENT TEAMING, the specification of which is incorporated by reference herein.

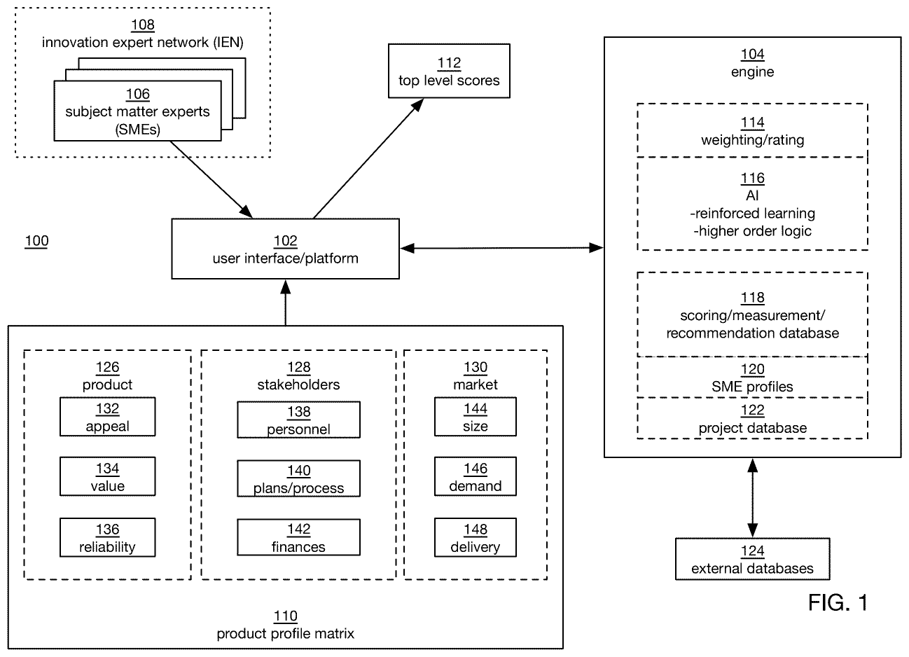

The preferred embodiment of the present invention will now be described with reference to the various Figures. FIG. 1 is a block diagram of the overall system and user interactions of the preferred embodiment of the present invention. The preferred embodiment system 100 (the Product Innovation Platform) has as its main components a user interface/platform 102 and a computing engine 104. A group of subject matter experts (SMEs) 106 form an innovation expert network 108 and interoperate with the engine 104 of the system 100 via the platform 102. The primary results of the work performed by the SMEs 106 with the engine 104 are a set of top level scores 112, which will be explained in further detail below.

The engine 104 may be a single computer or system of computers, accessible over a wide area network such as but not limited to the internet, that performs all of the data storage, processing, calculations, analysis, and artificial intelligence undertaken by the system 100 of the preferred embodiment of the present invention. The engine 104 will interface with the user interface/platform 102 that serves as the user interface, such as a web server, that allows interaction with the engine 104 by the various participants in the system such as end users, subject matter experts 106, and the like. The engine 104 includes a weighting/ranking module 114 that facilitates implementation of the fundamental prime measurements by the subject matter experts, and an artificial intelligence (AI) module 116 that uses higher order logic and reinforced learning in conjunction with the manual interactions of the subject matter experts 106. These modules are software modules programmed to perform the functions that are described in detail further herein.

The engine 104 also includes several databases such as an SME profile database 120 that implements a scoring system relevant to the qualifications of the network 108 of SMEs suitable for selection and engagement of appropriate SMEs 106 on a given project; as well as a scoring/measurement/recommendation database 118 that captures intelligence and stores historical data regarding scoring, fundamental prime measurements, and recommendations of the SMEs on past projects that may be accessed by the system (AI or manually) for implementation in subsequent projects, and a project database 122. These databases may be implemented in any available database software such as SQL or the like, as well known in the art. The databases 118, 120 and 122 may be stored on the same machine as the software comprising the engine 104, or they may be stored on a separate computer as may be desired. External databases 124 are also shown, which may be accessible via the internet to obtain information as will be further described herein.

The SME profiles database 120 tracks various data points for each SME 106 registered in the system. For example, in addition to the SME's name, title and contact information, the SME database 120 also tracks the compensation rate(s) for the SMEs, as well as a ranking score that reflects the desirability of the SME for subsequent work. This may be obtained through post-project evaluations from project administrators, other SMEs, etc. The SME database 120 may also indicate the current availability of an SME to work on a project, his education, experience and training levels, and a biographical statement that may be useful for future project selections.

The artificial intelligence (AI) methodology employed by the AI module 116 implements reinforced learning and higher order logic (HOL) along with mathematical power sets, which are illustrated graphically in FIG. 4B.

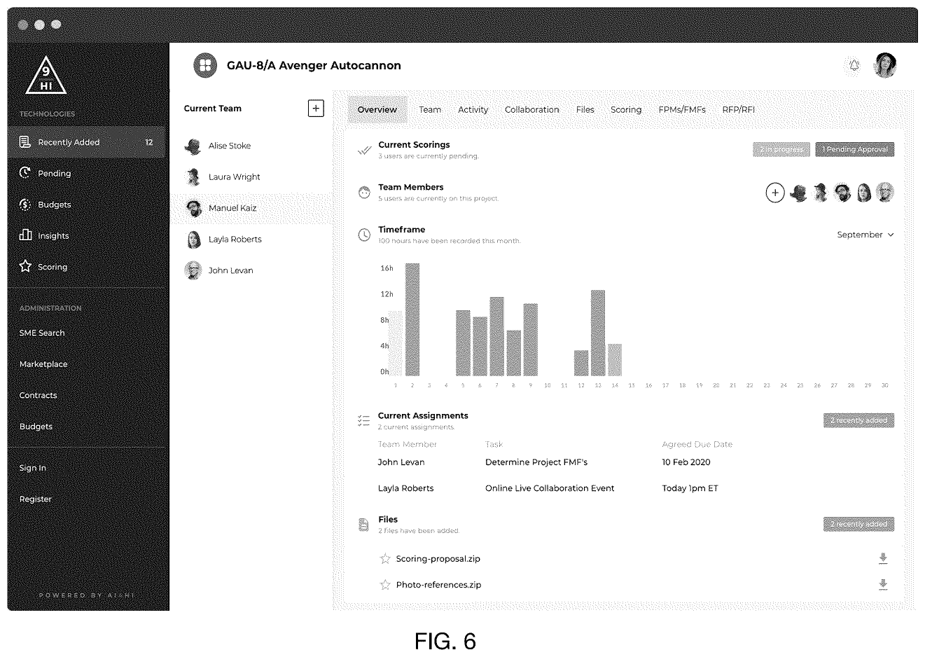

The user interface/platform 102 functions as the front end to the various users such as the SMEs 106, and as such may typically be a web server that interoperates over the internet or other wide area network (not shown for clarity), to provide for example a web page as shown in FIG. 6. Computer and network interoperations are well known in the art and need not be described in further detail herein.

Also shown graphically in FIG. 1 is a product profile matrix 110. The product profile matrix 110 is a construct of the system 100 that enables the SMEs 106 to generate accurate, timely, and robust data sets in order to map out various aspects of a product under development. The product profile matrix represents various power sets of data implemented by the system 100 and as such will be stored in and manipulated within the engine 104.

The product profile matrix 110 is a matrix of data that includes a top level set of three power sets; which are the product fundamental prime measurement power set 126, the stakeholders fundamental prime measurement power set 128, and the market fundamental prime measurement power set 130. These power sets include all data needed by the system in order to make product design and maintenance recommendations as determined in conjunction with the SMEs. Each power set is comprised of three fundamental prime measurements (FPMs) for a total of nine FPMs in the matrix. The product fundamental prime measurement power set 126 includes the appeal FPM power set 132, the value FPM power set 134, and the reliability FPM power set 136. Similarly, the stakeholders power set 128 includes the personnel FPM power set 138, the plans/process FPM power set 140, and the finances FPM power set 142. Finally, the market FPM power set 130 includes the size FPM power set 144, the demand FPM power set 146, and the delivery FPM power set 148.

Each of these nine FPM power sets are constructed from various underlying fundamental measurement factors, as depicted in FIGS. 2A, 2B, and 2C. SMEs and/or AI make recommendations based on scoring of these underlying fundamental measurement factors. In one embodiment, the final scores that are highest will automatically dictate which methodologies are implemented (e.g. the methodology with the highest score will be automatically implemented). In another embodiment, final scores are considered by a human decision maker but may not be the only factor considered in determining which methodology may be implemented in the product.

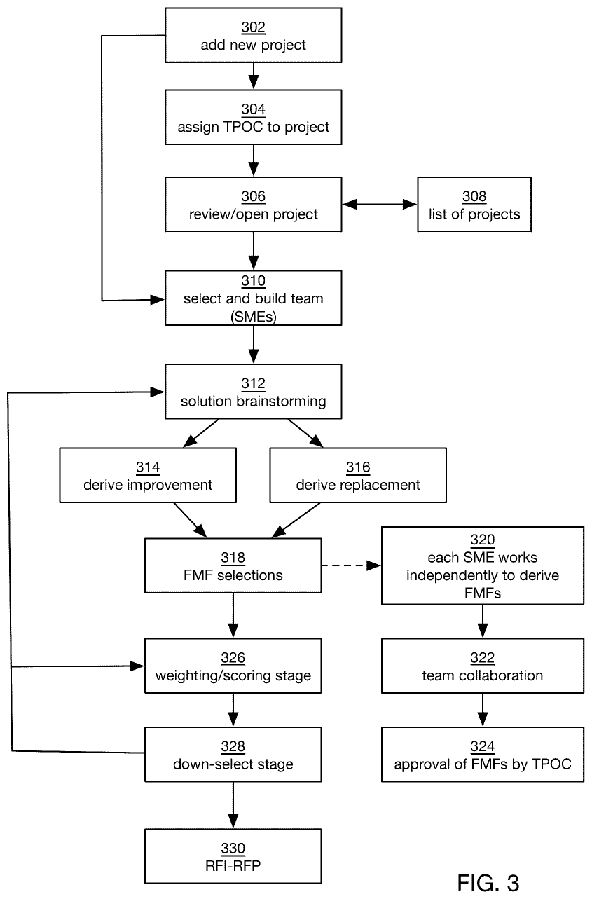

Referring to FIG. 3, the overall methodology implemented by the preferred embodiment is now described. At step 302, a new product development/design/redesign project is initiated, and at step 304, a technical point of contact (TPOC) is assigned to oversee development of the project. Technical points of contacts are generally those users of the system 100 who are responsible for the detailed determination and specification of technical requirements for products to be procured. The technical point of contact will, at step 306, review a list of existing projects 308 from the project database 122 to ascertain if a similar project has already been processed by the system, and if so, how much of the information stored in the database(s) may be reused for this project. Assuming that the new project has no historical precedent in the system, the technical point of contact will open a new project for processing.

At step 310, the technical point of contact will use the user interface 102 to select and build a team of subject matter experts. Subject matter experts are individuals who provide a profile of their skills so that they can be selected for a given project. SMEs also provide their desired compensation rate and rely on feedback ratings and contributions of knowledge to raise their score against their peers. This information may be stored in SME profile database 120.

In one embodiment in which the project is being implemented for or with a governmental agency (e.g. the Department of Defense, or DOD), an SME may be either a Government SME (G-SME) or an Industry SME (I-SME). A G-SME is generally a specialist in the government operations for which new products are being procured. They often are actual members of the user community-such as warfighters for defense applications-who bring a front-line understanding of user needs to the process. On the other hand, an I-SME is generally a specialist from industry, in defense markets and technology markets, with knowledge of technologies, products, and development techniques for products sought by the government. They can be engaged either early in the project as early measurements and scope are being derived, or after a development contract has been won by a contractor.

Subject matter experts form what is referred to as the Innovation Expert Network (IEN) 108. This is a membership organization that allows access by the project leader to select a team of SMEs to execute various tasks of the project. The IEN 108 is a social network of professionals who provide expertise and knowledge in various technical and product areas. It provides a means to upload personal capabilities and interests to create a personal/professional profile for each expert. Both government and industry personnel can access the IEN 108 to identify SMEs needed for various product development efforts.

The subject matter experts may be reviewed by using a web site implementing a web page(s) as shown in FIG. 6. The web page of FIG. 6, which in this teaching example is show being used for a project entitled “GAU-8/A Avenger Autocannon,” provides the technical point of contact the ability to view data related to all of the available SME's in the system. By selecting the button labelled “SME Search”, the SME database 120 becomes available for searching. In the example of FIG. 6, a set of five SMEs have already been chosen, as listed in the column labelled “Current Team.” By selecting any of the subject matter experts on the current team, e.g. Laura Wright, their bio, availability, and other pertinent information is accessible.

The set of desired SMEs is chosen based upon criteria retrieved from the SME profiles database 120, including technical level of skill relevant to the current project, salary requirements, experience, and availability to work on the project. The technical point of contact will communicate with the selected SMEs to negotiate an agreement for them to work on the project. Eventually the final team of SMEs will be formed, and the project development project continues.

At step 312 of FIG. 3, an initial solution brainstorming process may be undertaken with the SMEs on the project, which may include any or all of the following: identify technology and select/assign the technology to standardized classification of family, phylum etc., create a taxonomy structure, establishment of a budget, and the like. Initial improvements may be derived (step 314), and/or replacements may be derived (step 316) at this stage.

The SMEs (operating optionally in conjunction with the artificial intelligence module) then execute an iterative process, the goal of which is to generate the product profile matrix 110 of FIG. 1. The product profile matrix 110 will be the framework by which the new product will be designed for maximum benefits such as cost, efficiency, reliability, etc. As previously described, the product profile matrix 110 includes three power sets of fundamental prime measurements (FPMs), which are defined as the product fundamental prime measurement power set 126, the stakeholders fundamental prime measurement power set 128, and the market fundamental prime measurement power set 130. In the preferred embodiment, the product fundamental prime measurement power set 126 includes the following three fundamental prime measurements: appeal 132, value 134, and reliability 136. The stakeholder fundamental prime measurement power set 128 includes the following three fundamental prime measurements: personnel 138, plans/process 140, and finances 142. The market fundamental prime measurement power set 130 includes the following three fundamental prime measurements: size 144, demand 146, and delivery 148. As such, all underlying parameters, factors and considerations that will be evaluated by the SMEs in generating the product profile matrix 110 can be grouped or categorized into one of these nine fundamental prime measurements. In particular, these underlying parameters, factors and considerations are referred to as fundamental measurement factors (FMFs).

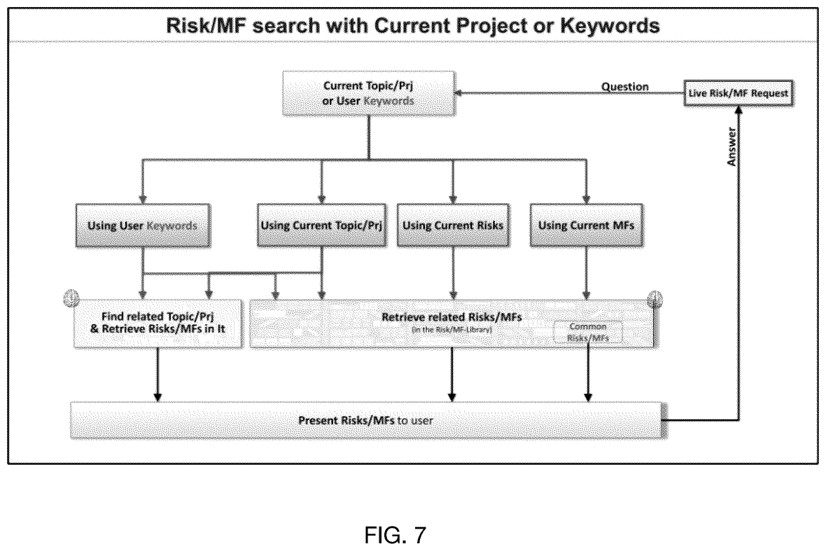

The product profile matrix is generated by selecting from a project database stored on a computer, a plurality of fundamental measurement factors, wherein artificial intelligence is implemented to at least partially assist in selecting at least one of the fundamental measurement factors. The following description specifically shows the process of how risks and fundamental measurement factors are identified and recommended to the user that would form the basis of each of the nine FPM scores.
a. Risk/Success Measurement Factor (MF) Al Agent Internals: During the live Risk/MF request by the user, the Al agent receives (1) the user's current project ID, and (2) “user keywords” that the user uses to search for related Risks/MFs.
b. When the Al Agent receives the two inputs, the Al Agent executes seven processes shown in FIG. 7.

As shown in detail in FIG. 7,
1. Using the current project's topic, finds a similar prior project (or topic) in its database, and retrieves all of its risks/MFs.
2. Using the current project's risks, retrieves related risks/MFs in the risks/MF-library.
3. Using current project's MFs, retrieves related risks/MFs in the risks/MF-library.
4. Using current project's topic, retrieves related risks/MFs in the risks/MF-library.
5. Using the user keywords, find a similar project (or topic) in its database; and retrieves all risks MFs in the related project.
6. Using the user keywords, retrieves related risks/MFs in the risks/MF-library.
7. Retrieves the common risks/MFs.
c. After retrieving risks/MFs using the seven processes described above, the retrieved risks/MFs are sent to the user as the Al Agent's recommendation.
d. During the risks/MF search-retrieval processes described above (excluding the Common MF retrieval), the natural language processing (NLP) is performed by the Al Agent. The brain-looking icons in FIG. 7 indicate the portions utilizing the LP Al.

In essence, these fundamental measurement factors are a subset of approximately 5-10 customized measurements that are used to calculate each of the nine fundamental prime measurements (FPMs) that together form the product profile matrix 110. Thes fundamental measurement factors are derived by the subject matter experts and are extracted from a library in the project database 122 and modified as necessary or derived at the onset of the project.

FIGS. 2A, 2B and 2C each illustrate a typical set of fundamental measurement factors used to calculate the product 126, stakeholders 128, and market 130 fundamental prime measurement power sets in the product profile matrix, respectively. These fundamental measurement factors are selected (by the SMEs and or the AI module 116) and then grouped into the fundamental prime measurement power sets as follows:

### Product Fundamental Prime Measurement Power Set 126:

1. Appeal fundamental prime measurement 132
   What is the range of use of the product?
   How do you characterize the newness and/or refreshability of the product?
   Is the product easily repaired, or must it be replaced often?
   How is the product tailored to the target customer?
   How easy or difficult is it to use the product?
2. Value fundamental prime measurement 134
   How do the function and price interrelate to each other?
   Does the product have multiple capabilities or is it only good for one particular use?
   Can there be a simpler design of the product?
   Can the product be made with greater precision?
   Can the incremental cost of the product be made lower?
3. Reliability fundamental prime measurement 136
   Does the product meet customer expectations?
   Does the product perform on par with the competition?
   Is the robustness of the product well defined?
   Does the product have proven durability/life considerations?
   Are the materials proven for his use case?

### Stakeholder Fundamental Prime Measurement Power Set 128:

4. Personnel fundamental prime measurement 138
   Are the responsibilities of each stakeholder understood?
   Will the project use salaried or contract personnel?
   Is each organization tailored to launch?
   Are the relevant personnel trained?
   Is the relevant organization flat?
5. Plans/process fundamental prime measurement 140
   Is the project plan complete and is it used properly?
   Is there any existing infringement of others' intellectual property?
   Is the product lifestyle acceptable?
   Are there alternate plans available?
6. Finances fundamental prime measurement 142.
   Do the short and long term financial goals conflict with each other?
   Are the fixed costs low?
   Are the variable costs low?
   Has a tangible business plan been completed?
   Are cash requirements understood?

### Market Fundamental Prime Measurement Power Set 130:

7. Size fundamental prime measurement 144
   Can market fragments be consolidated?
   What is the longevity of the target application?
   What is the scalability of the project?
   Are there product life cycle advantages?
   Could other disruptive technologies diminish market size?
8. Demand fundamental prime measurement 146
   Are there established applications for the product?
   Are users targeted in design/development?
   Is the product affordable to customers?
   Will satisfaction of the customer be guaranteed?
   What is the level of market anticipation?
9. Delivery fundamental prime measurement 148
   Are there barriers to entry?
   Are the distribution requirements understood?
   Has customer feedback been implemented?
   Is there a fast enough response to change demand?
   Is there a short lead time for new customers?

In essence, the fundamental prime measurements are an organized superset of the individual fundamental measurement factors as set forth above and are implemented in order to identify opportunities and risks associated with a given project. For any given product development cycle, all risks/opportunities are categorized into the FPMs; i.e., there is no risk or opportunity that exists outside of the nine FPMs as defined above. Although the specific individual fundamental measurement factors may vary from project to project based on decisions made by the SMEs, the nine fundamental prime measurements will always be present. For example, the appeal FPM 132 of a product 126 will always be a factor in the product profile matrix, even though the constituent fundamental measurement factors that determine the product's appeal 132 may vary from project to project, based on the specific requirements of the project.

Thus, referring again to FIG. 3, at step 318, the fundamental measurement factors are selected by the team of SMEs. The SMEs recommend the appropriate measurement fundamental measurement factors for each of the nine fundamental prime measurement power sets. As shown by step 320, each subject matter expert will work independently to derive the appropriate fundamental measurement factors, at which point a team collaborative process occurs amongst the SMEs at step 322 to review and revise the FMFs, which are eventually approved by the technical point of contact at step 324.

Once the fundamental measurement factors have been decided on for the project, a weighting and scoring process for those FMFs is undertaken at step 326. For each of the fundamental measurement factors, the SME will assign a relative weight that reflects the importance of that particular fundamental measurement factor to the current project being analyzed. Since the weight of any given fundamental measurement factor will vary across various projects, its relative contribution to that project varies accordingly. For example, the following weighting (or importance rating) scale is implemented in the preferred embodiment of this invention:

TABLE 1
Importance Ratings

| Weight | Meaning |
|---|---|
| 5 | Absolutely necessary |
| 4 | Important |
| 3 | Good to have |
| 2 | Minor contribution |
| 1 | Never needed |

For example, a product having a primary use case in a remote wilderness area would have a repairability factor with a higher weight (e.g. 5) than would a product whose primary use case is in an area where product replacement is relatively easy (e.g. 2). That is, something that cannot be easily replaced (since its use is remote) must be easily repaired to be viable. In another example, a product that is expected to be produced in very small quantities would have a scalability factor that is weighted relatively lower (e.g. 1) than that of a product that is expected to be produced in higher quantities (e.g. 4). Each of the fundamental measurement factors is thus weighted by the SMEs in accordance with the specifics of that project.

In addition, an evidence score is assigned to each fundamental measurement factor by the responsible SME. The evidence score will reflect how well the proposed product meets that factor based on available evidence. The following evidence scoring scale is implemented in the preferred embodiment of this invention:

TABLE 2
Evidence Scoring Scale

| Scoring | |
|---|---|
| Range | Definition of Evidence Criteria |
| 9.0-9.9 | Confirmed evidence of Risk |
| | reduction from multiple sources/ |
| | superior performance. Risks are |
| | adequately addressed. |
| 8.0-8.9 | Confirmed evidence of Risk |
| | reduction with actual or highly |
| | similar prototype technology. |
| | Team and Application Risks & SFs |
| | are being addressed but not |
| | completely resolved. |
| 7.0-7.9 | Limited demonstration success, |
| | resulting in evidence available and |
| | Risks addressed or potentially |
| | addressed in a development plan |
| 6.0-6.9 | Convincing theories & arguments |
| | are grounded with evidence |
| | Development Risks reduction |
| | plans are reasonable but |
| | unproven. |
| 5.0-5.9 | High fidelity integration of |
| | prototype, detailed schedule, and |
| | cost planning lead to scope of |
| | technology performance expected/ |
| | Development Risks identified |
| | through TRL 9. |
| 4.0-4.9 | Low fidelity evidence is produced |
| | for aspects of a prototype of |
| | directional evidence of Success, |
| | which now allows for a |
| | Development plan through TRL 9. |
| 3.0-3.9 | Analytical studies and/or |
| | laboratory studies show validation |
| | of predictions. |
| 2.0-2.9 | Applied research is starting to be |
| | conducted and basic principles are |
| | observed but not reduced to |
| | usable form. |
| 1.0-1.9 | Theoretical concept(s) exist, only |
| | paper studies are available or are |
| | still being created. |

For example, a certain product may not be easily repairable, so the score for the repairability factor would be very low, for example a 5 (weak performance evidence). Evidence scores may be obtained through various methods, including prior performances that are stored in the scoring/measurement/recommendation database 118, external databases 124, personal knowledge of the SMEs, etc. For example, if an SME is able to confirm that a given factor has scored high based on prior history within the system, as well as reference to web-based sources (external databases), then he or she may assign a level 9 to that factor since there is confirmed evidence from more than one source (prior history and external web data) of superior performance. As such, the more a given factor is analyzed in the system over various projects, the more evidence may be obtainable on it, and the more likely that the confidence level will increase accordingly.

A total point score for each fundamental prime measurement is derived by analyzing each constituent fundamental measurement factor by multiplying the weight of that fundamental measurement factor by the evidence score as shown in the following algorithm:

$$Fundamental Prime Measurement ( FPM ) Score Derivation :$$

$$FPM = \frac{( M {F}_{1} \times {W}_{1} ) + ( M {F}_{2} \times {W}_{2} ) + … ( {MF}_{n} \times {W}_{n} )}{{W}_{1} + {W}_{2} + … {W}_{n}}$$

$$= \frac{{\sum }_{1}^{n} ( {MF}_{n} \times {W}_{n} )}{{\sum }_{1}^{n} {W}_{n}}$$

$$Where , MF = Measurement Factor$$

$$W = Weight$$

$$n = number of MFs utilized$$

All nine fundamental prime measurements are then calculated using the above algorithm.

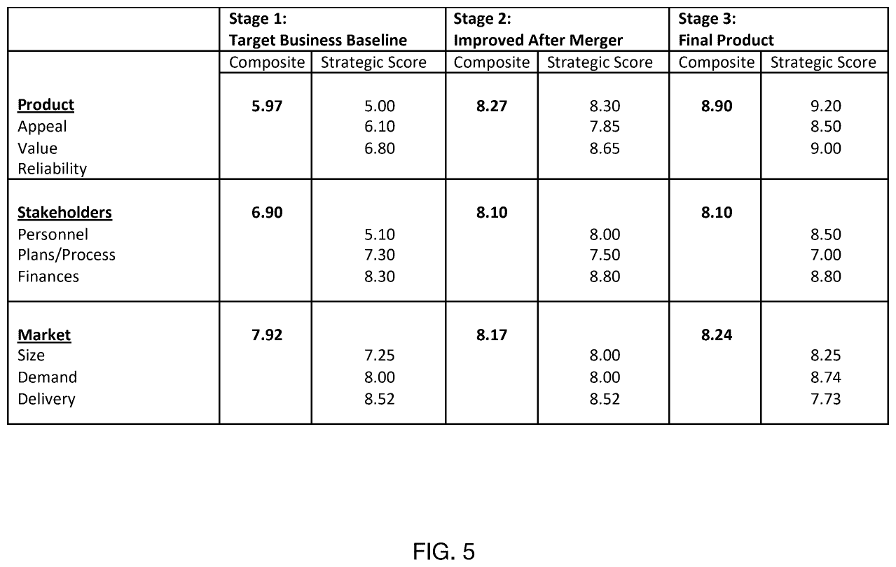

In an alternative embodiment, an additional skewing factor may be used to further distinguish and separate differently weighted factors (e.g. a weighting of 5 may actually result in a multiplication factor of 20). In any event, as shown in the above algorithm, all of the total points scores for the fundamental measurement factors that constitute each fundamental prime measurement power set are summed, and then the average is calculated as the strategic score for that fundamental prime measurement. The result will be a set of nine strategic scores as shown in FIG. 5. There, the strategic scores are shown for the nine FPMs (appeal, value, reliability, personnel, plans/process, finances, size, demand, delivery). The strategic scores that are generated for the first iteration of the analysis are referred to as stage 1 scores. Also shown in FIG. 5 is the composite score for each fundamental prime measurement power set (product fundamental prime measurement power set, stakeholder fundamental prime measurement power set, and market fundamental prime measurement power set), which is derived by averaging the strategic scores of the FPMs that comprise each fundamental prime measurement power set. For example, the composite score for the product fundamental prime measurement power set (5.97) is the average of the strategic scores of its constituent FPMs of appeal (5.00), value (6.10), and reliability (6.80).

Weighting factors and skewing factors may be adjusted as desired by the system designer in order to provide a meaningful range of scores that accurately reflect differences in the various factors and achieve a level of granularity and precision that is meaningful and robust. At step 328, the down-select stage is entered, where the composite scores are further analyzed to determine if they have met a certain level of acceptability. A break point range is defined against which the composite scores are compared to make this determination. In the preferred embodiment, the following break point range is utilized.

TABLE 3
Risk Analysis

| Range | Risk level |
|---|---|
| <7.00 | High risk |
| 7.00 < > 8.00 | Marginal |
| >8.00 | Low risk |

Thus, the composite score of 5.97 for the product fundamental prime measurement power set is a high risk, but the composite score of 7.92 for the market fundamental prime measurement power set is marginal. In fact, all three FPMs for the product subset had strategic scores that were high risk (5.00 for Appeal, 6.10 for Value, and 6.80 for Reliability). All three of these FPMs will need to be improved upon in order to drive the composite score for the product subset into an acceptable range. In the market fundamental prime measurement power set, the demand strategic score of 8.00 and the delivery strategic score of 8.52 are low risk, but the marginal score for the size FPM of 7.25 drove the composite subset into the marginal range. Thus, only the size FPM needs to be addressed in order to drive the composite score for the market fundamental prime measurement power set into the low risk range.

Since at least some of the FPMs require improved scores, the process loops back to step 312, where further solution brainstorming takes place or product development and testing may be required. The SMEs can analyze the FPMs/FMFs that require improvement, and then implement revisions to the various processes at steps 314 and 316 that will cause the FPMs to increase, thus driving the scores in the desired direction. For example, at stage 2, the scores have dramatically increased as can be seen in FIG. 5. The process in this example reiterates once more, resulting in the composite scores shown for stage 3 (Final Product) in FIG. 5, all of which are in the low risk range. Optionally, the new iteration may re-enter the process flow at step 326 for the weighting and scoring stage.

Once acceptable composite scores are attained, the process proceeds to step 330, where RFIs (requests for information) and RFPs (requests for proposal) may be disseminated as well known in the industry. In one embodiment, scores generated by the system may be shared with proposed vendors, wherein those vendors are able to match the scores to their own stored capabilities to provide for a more seamless interaction.

In the preferred embodiment, a library of fundamental measurement factors is stored, for example in the project database shown in FIG. 1. Subject matter experts, acting individually and/or in concert with the artificial intelligence (AI) engine, will review the available fundamental measurement factors for a give type of project and develop a subset of those fundamental measurement factors that are deemed especially relevant to the current project. As shown in FIGS. 2A, 2B, and 2C, five of the most relevant fundamental measurement factors have been selected for his example for clarity of explanation; it is noted that dozens or even hundreds of such fundamental measurement factors may be utilized for a given project, as ascertained by the SMEs and/or AI engine. As the analysis of the available fundamental measurement factors, as well as their related scores sored from past projects, becomes more intricate, the system will rely more on the AI engine to cull out the most relevant FMFs for a given project.

When reviewing the library of fundamental measurement factors, the AI engine will determine which particular fundamental measurement factors were implemented on similar programs as the current one, and which of those helped to make that prior program successful. This automated process of culling out the most relevant fundamental measurement factors for a given program provides reliability and accuracy in the present invention since it saves critical amounts of time.

As scores are generated and evaluated for the various fundamental measurement factors, this data is stored in the scoring/measurement/recommendation database as shown in FIG. 1. The library of available data increase with each project so that subsequent projects can extract fundamental measurement factor scoring information for similar factors in order to streamline and make more efficient the product design process being undertaken. For example, a given project may be to upgrade the accuracy of a certain type of weapon; in this case the AI engine can review the fundamental measurement factors in which similar weapons have been designed with similar feature sets and in which the accuracy of such prior weapon designs has been considered to superior.

The scores that are used in this embodiment are relevant to specific design parameters such that changing the design parameters would change the score in accordance with the needs of the project. For example, use of a certain material (material A) for a given application may have an associated reliability score that is relatively high, but a value score that is low since its reliability makes it expensive. A second material (material B) may not be as reliable as material A, but it may cost less and thus have a higher value score. The subject matter expert and/or AI module can thereby choose either material depending on the relative importance of reliability vs. cost, analyze the effect on the product profile matrix, and adjust the material selection accordingly.

What is claimed is:

1. A computer-implemented method for generating a set of parameters for a design of a product comprising:
generating, by a computer, a product profile matrix that comprises a power set of fundamental prime measurements, wherein each of said fundamental prime measurements comprises a power set of fundamental measurement factors associated with a design aspect of the product, wherein said product profile matrix is generated by:
i. for each of the fundamental prime measurements, selecting from a project database a plurality n of fundamental measurement factors relevant to the fundamental prime measurement,
ii. assigning a weight of importance W to each of the plurality of fundamental measurement factors,
iii. assigning an evidence score MF to each of the plurality of fundamental measurement factors,
iv. generating a strategic score FPM for each fundamental prime measurement as a function of the weight W and evidence score MF for each of the n fundamental measurement factors by implementing the algorithm
$$FPM = \frac{( {MF}_{1} \times {W}_{1} ) + ( {MF}_{2} \times {W}_{2} ) + … ( {MF}_{n} \times {W}_{n} )}{{W}_{1} + {W}_{2} + … {W}_{n}}$$
$$= \frac{{\sum }_{1}^{n} ( {MF}_{n} \times {W}_{n} )}{{\sum }_{1}^{n} {W}_{n}}$$
v. generating a set of composite scores for the power set of fundamental prime measurements as a function of the strategic scores;
vi. comparing each composite score to a risk scale to determine if the composite score of the fundamental prime measurement is acceptable; and
vii. if a composite score is below an acceptable risk level of the risk scale, then modifying at least one of the constituent fundamental measurement factors and repeating steps (ii)-(vi) until the composite score is not below the acceptable risk level of the risk scale, resulting in an optimized set of parameters for the design of the product.

2. The method of claim 1 wherein the at least one constituent fundamental measurement factor is modified by providing a modified evidence score MF.

3. The method of claim 1 wherein the at least one constituent fundamental measurement factor is modified by providing a modified weight W.

4. The method of claim 1 wherein the risks are classified as a gap, vulnerability or barrier, and further wherein the process terminates if any composite score or strategic score equates to a barrier.

5. The method of claim 1 wherein the composite score is the average of the underlying strategic scores.

6. The method of claim 1 wherein the fundamental prime measurements comprise product appeal, product value, product reliability, stakeholder personnel, stakeholder process, stakeholder finances, market size, market demand, and market delivery.

7. The method of claim 1 comprising the further steps of storing the strategic scores in a database for reuse in a subsequent design project.

8. The method of claim 1 wherein at least one of the fundamental measurement factors selected from the project database has an associated previous total point score.

9. The method of claim 1 further comprising the step of selecting a plurality of subject matter experts, each of said subject matter experts having expertise in at least one aspect of the design of the product, wherein the subject matter experts select at least one of the fundamental measurement factors.

10. The method of claim 9 further wherein artificial intelligence is implemented to at least partially assist the subject matter experts in selecting the fundamental measurement factors.

11. A non-transitory computer readable medium having stored thereon software instructions for generating a set of parameters for a design of a product that, when executed by a processor, cause the processor to:
generate a product profile matrix that comprises a power set of fundamental prime measurements, wherein each of said fundamental prime measurements comprises a power set of fundamental measurement factors associated with a design aspect of the product, wherein said product profile matrix is generated by:
i. for each of the fundamental prime measurements, selecting from a project database a plurality n of fundamental measurement factors relevant to the fundamental prime measurement,
ii. assigning a weight of importance W to each of the plurality of fundamental measurement factors,
iii. assigning an evidence score MF to each of the plurality of fundamental measurement factors,
iv. generating a strategic score FPM for each fundamental prime measurement as a function of the weight W and evidence score MF for each of the n fundamental measurement factors by implementing the algorithm
$$FPM = \frac{( {MF}_{1} \times {W}_{1} ) + ( {MF}_{2} \times {W}_{2} ) + … ( {MF}_{n} \times {W}_{n} )}{{W}_{1} + {W}_{2} + … {W}_{n}}$$
$$= \frac{{\sum }_{1}^{n} ( {MF}_{n} \times {W}_{n} )}{{\sum }_{1}^{n} {W}_{n}}$$
v. generating a set of composite scores for the power set of fundamental prime measurements as a function of the strategic scores;
vi. comparing each composite score to a risk scale to determine if the composite score of the fundamental prime measurement is acceptable; and
vii. if a composite score is below an acceptable risk level of the risk scale, then modifying at least one of the constituent fundamental measurement factors and repeating steps (ii)-(vi) until the composite score is not below the acceptable risk level of the risk scale, resulting in an optimized set of parameters for the design of the product.

12. The non-transitory computer readable medium of claim 11 wherein the at least one constituent fundamental measurement factor is modified by providing a modified evidence score MF.

13. The non-transitory computer readable medium of claim 11 wherein the at least one constituent fundamental measurement factor is modified by providing a modified weight W.

14. The non-transitory computer readable medium of claim 11 wherein the risks are classified as a gap, vulnerability or barrier, and further wherein the process terminates if any composite score or strategic score equates to a barrier.

15. The non-transitory computer readable medium of claim 11 wherein the composite score is the average of the underlying strategic scores.

16. The non-transitory computer readable medium of claim 11 wherein the fundamental prime measurements comprise product appeal, product value, product reliability, stakeholder personnel, stakeholder process, stakeholder finances, market size, market demand, and market delivery.

17. The non-transitory computer readable medium of claim 11 comprising the further steps of storing the strategic scores in a database for reuse in a subsequent design project.

18. The non-transitory computer readable medium of claim 11 wherein at least one of the fundamental measurement factors selected from the project database has an associated previous total point score.
